(19) United States
(12) Patent Application Publication
(10) Pub. No.: US 2002/0052822 A1
(43) Pub. Date: May 2, 2002

(54) Transaction supporting method and recording medium

(76) Inventor: Shigehiko Terashima, Kawasaki (JP)

Correspondence Address: STAAS & HALSEY LLP, 700 11TH STREET, NW, SUITE 500, WASHINGTON, DC, 20001, US

(21) Appl. No.: 09/803,134

(22) Filed: Mar. 12, 2001

(30) Foreign Application Priority Data
Nov. 1, 2000 (JP) 2000-334499

(51) Int. Cl. G06F 17/60

(52) U.S. Cl. 705/37

(57) ABSTRACT

There is provided a transaction supporting apparatus capable of increasing opportunity for making agreement within the ranges desired by investors. A price specifying unit can specify a buying or selling price of securities so as to have a given range. A volume specifying unit can specify a buying or selling volume of securities so as to have a given range. A condition specifying unit can specify partial agreement between buying and selling orders. An order unit issues an order for the specified volume of securities at the specified price under the conditions.

### BACKGROUND OF THE INVENTION

(1) Field of the Invention

The present invention relates to a transaction supporting method and an apparatus, and more particularly to a method and an apparatus for supporting securities transactions. The present invention is also concerned with a computer-readable recording medium that stores a program implementing the method.

(2) Description of the Related Art

In a transaction of trading securities such as stocks and bonds, a prospective buyer who offers the most advantageous price to a person who wishes to sell the securities will fulfill the transaction and vice versa.

In transactions in stocks or the like, persons involved in trading stocks are provided with information that facilitates these transactions. Such information may include the current status of the stock market and appropriate times for selling and buying that are based on an analysis of the current status of the stock market.

An electronic securities transaction market has recently come into wide use in which securities transactions are electronically completed between specific members.

In a conventional securities transaction, trading parties are chosen on the basis of price alone. In other words, other factors involved in selling and buying are not reflected satisfactorily.

Further, a buying or selling price can be set at only one price under the law of one price. Thus, it is impossible to set such conditions even if a desired price has a price range.

### SUMMARY OF THE INVENTION

Taking the above into consideration, an object of the present invention is to provide a transaction supporting method and apparatus capable of reflecting a factor other than price in securities transactions.

It is another object of the present invention to provide a transaction supporting method and apparatus capable of setting a condition in trading such as a desired price range or a desired dealing volume.

To accomplish the above objects, according to the present invention, there is provided a transaction supporting method including the steps of: (a) specifying a price of securities to be bought or sold; (b) specifying a volume of the securities; (c) specifying conditions for buying or selling the securities; and (d) issuing an order for the volume of the securities at the price under the conditions.

The above objects are also achieved by a transaction supporting apparatus that includes: a unit for specifying a price of securities to be bought or sold; a unit for specifying a volume of the securities; a unit for specifying conditions for buying or selling the securities; and a unit for issuing an order for the volume of the securities at the price under the conditions.

The present invention will become apparent from the following description when taken in conjunction with the accompanying drawings which illustrate preferred embodiments of the present invention by way of example.

### BRIEF DESCRIPTION OF THE DRAWINGS

FIG. 1 illustrates an aspect of the present invention;

FIG. 2 is a block diagram of an embodiment of the present invention;

FIG. 3 illustrates an example of a screen displayed on a display unit of an investor client that inquires about a market quotation;

FIG. 4 illustrates an example of a screen displayed at the investor client when an answer to the inquiry is received;

FIG. 5 illustrates an example of an order screen displayed when a securities code is clicked on the screen shown in FIG. 4;

FIG. 6 illustrates an example of a screen displayed on a display unit of a transaction supporting apparatus before a “send” button on the order screen is operated;

FIG. 7 illustrates an example of a screen displayed on the display unit of the transaction supporting apparatus when given conditions are input on the order screen shown in FIG. 5 and then a “send” button is operated;

FIG. 8 illustrates an example of a screen displayed at other investor clients;

FIG. 9 illustrates an example of a screen displayed at the transaction supporting apparatus when an order is specified as a hidden one by checking a corresponding check box on the screen shown in FIG. 5;

FIG. 10 illustrates an example of a screen at other investor clients when an order is specified as a hidden one by checking the check box on the screen shown in FIG. 5;

FIG. 11 illustrates an example of a screen that displays agreement status;

FIG. 12 illustrates an example of a screen displayed on the display unit of an investor client when the order conditions for trading by a previous order is amended;

FIG. 13 illustrates an example of a screen displayed on the display unit of the transaction processing apparatus when agreement is made after amending the order conditions for trading;

FIG. 14 illustrates an example of a screen formed when an order is canceled after agreement is made on the screen shown in FIG. 13;

FIG. 15 is a flowchart of an example of a process executed by the transaction processing apparatus shown in FIG. 2;

FIG. 16 is a flowchart of the details of a market quotation display process in step S11 shown in FIG. 15;

FIG. 17 is a flowchart of the details of an order process in step S13 shown in FIG. 15;

FIG. 18 is a flowchart of the details of an agreement verification process in step S53 shown in FIG. 17;

FIG. 19 is a flowchart of the details of a condition amendment process in step S15 shown in FIG. 15;

FIG. 20 is a flowchart of an example of a process executed by the securities transaction server shown in FIG. 2; and

FIG. 21 is a flowchart of another process executed by the securities transaction server shown in FIG. 2.

### DESCRIPTION OF THE PREFERRED EMBODIMENTS

Preferred embodiments of the present invention will be described below with reference to the accompanying drawings.

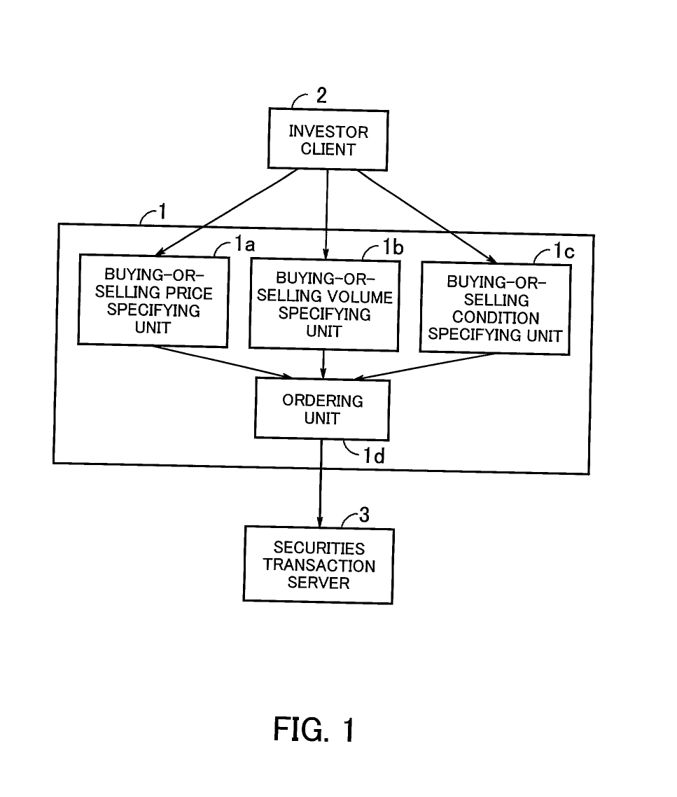

FIG. 1 illustrates an aspect of the present invention. A transaction supporting apparatus 1 shown in FIG. 1 includes a buying-or-selling price specifying unit 1a, a buying-or-selling volume specifying unit 1b, a buying-or-selling condition specifying unit 1c, and an ordering unit 1d. The apparatus 1, which is installed in a securities exchange, accepts a buying or sell order for securities sent by an investor client 2, and passes the received order to a securities transaction server 3.

The buying-or-selling price specifying unit 1a receives a specified buying or selling price for securities to be traded. The buying-or-selling volume specifying unit 1b receives a specified volume of securities to be bought or sold. The buying-or-selling condition specifying unit 1c receives specified conditions placed on the buying or selling of the securities. The ordering unit 1d passes to the securities transaction server 3 an order that meets the conditions specified by the buying-or-selling price specifying unit 1a, the buying-or-selling volume specifying unit 1b and the buying-or-selling condition specifying unit 1c.

The investor client 2, which is arranged on an investor side, receives the buying or selling order and sends it to the transaction supporting apparatus 1.

The securities transaction server 3, which is installed in a securities exchange, verifies whether the buying and selling orders from the transaction supporting apparatus 1 agree. When the buying and selling orders do agree, the securities transaction server 3 informs the investor clients 2 of the agreement via the transaction supporting apparatus 1.

For the sake of simplicity, FIG. 1 shows only a single investor client 2 and only a single transaction supporting apparatus. In practice, a plurality of investor clients and transaction supporting apparatuses would be involved in typical transactions.

The operation of the system shown in FIG. 1 is described immediately below.

It is assumed that an investor who is a user of the investor client 2 operates an input device (not shown) to a buying or selling order for securities. In this case, the buying-or-selling price specifying unit 1a receives a specified buying or selling price for the securities. The specified price may be a desired price, an upper limit price, or a lower limit price.

The buying-or-selling volume specifying unit 1b receives a specified buying or selling volume of the securities. The specified volume may be a desired buying or selling volume, an upper limit volume, or a lower limit volume.

The buying-or-selling condition specifying unit 1c receives a specified buying or selling condition for the securities. Partial agreement between the buying and selling orders may be an allowed condition.

It is assumed that a selling order has a desired selling price of 4000, an upper limit price of 4050, and a lower limit price of 3990; a desired selling volume of 100, an upper limit volume of 100, and a lower limit volume of 90; and a condition such that a partial agreement with a buying order is allowed.

The above selling order is passed to the securities transaction server 3 via the ordering unit 1d. The securities transaction server 3 verifies whether the received selling order is matched with a buying order from the transaction supporting apparatus 1 or another transaction supporting apparatus (not shown).

For example, if there is a buying order having a price of 4050 and a volume of 90, this buying order would fall within the specified price range of the selling order (3990<4050≦4050) from the investor client 2, and also fall within the volume range thereof (90≦90<100). Thus, the buying order would come to an agreement with the selling order.

If there is a buying order having a price of 3990 and a volume of 50, this buying order would fall within the specified price range of the selling order from the investor client 2, but would not meet the specified volume of the selling order. In the case being concerned, partial agreement is defined, as described before. Therefore, the buying and selling orders come to an agreement at a price of 3990 for only a volume of 50. If partial agreement is inhibited, the selling order would not be matched with the buying order.

After the selling order comes to an agreement with the buying order, the investor client 2 that issued the selling order via the transaction supporting apparatus 1 is informed that the selling order has come to an agreement with a buying order. Similarly, the person who issues the buying order is informed that the buying order has arrived at an agreement with a selling order.

As described above, according to the present invention, the buying-or-selling price specifying unit 1a specifies a buying or selling price range, and the buying-or-selling volume specifying unit 1b specifies a buying or selling volume range. Further, the buying-or-selling condition specifying unit 1c specifies conditions that permits or inhibit partial agreement between the buying and selling orders. Therefore, it is possible to clearly reflect the intent of investors. This urges general investors to join the market, so that trading activity should increase.

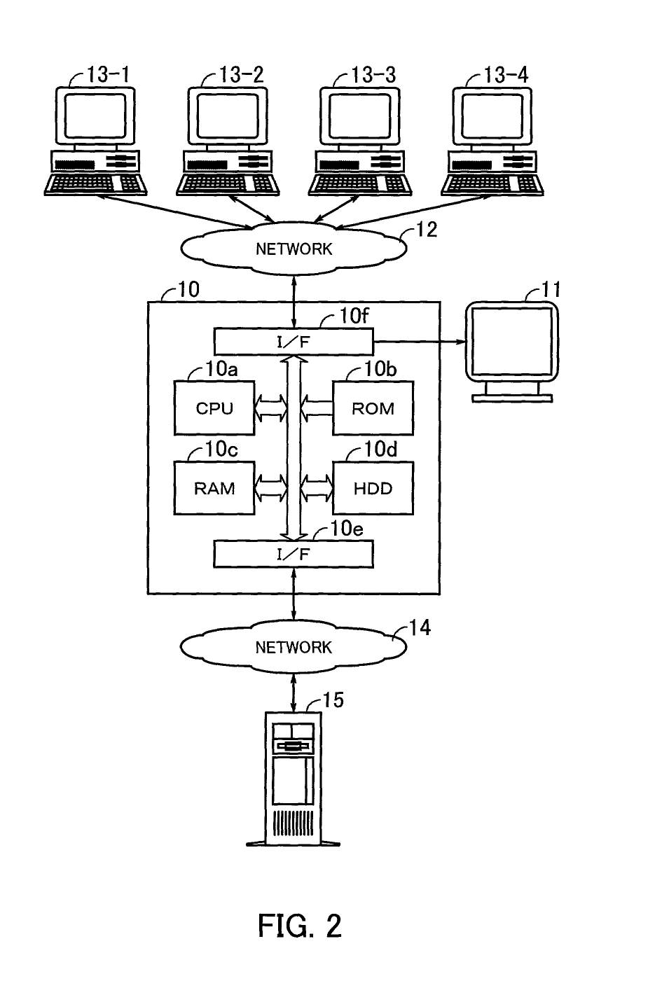

An embodiment of the present invention is described immediately below with reference to FIG. 2.

FIG. 2 is a diagram of an embodiment of the present invention. Referring to FIG. 2, a transaction supporting apparatus 10 receives buying or selling orders from investor clients 13-1 to 13-4 through a network 12, and sends the received orders to a securities transaction server 15 through a network 14.

The transaction supporting apparatus 10 is made up of a CPU (Central Processing Unit) 10a, a ROM (Read Only Memory) 10b, a RAM (Random Access Memory) 10c, an HDD (Hard Disk Drive) 10d, and I/F (InterFace) units 10e and 10f. A display unit 11 is connected to the transaction supporting apparatus 10.

The CPU 10a executes various operational processes to control the other components in accordance with programs stored in the HDD 10d. The ROM 10b stores basic programs to be executed and data to be processed by the CPU 10a. The RAM 10c stores a program currently being executed by the CPU 10a and temporarily stores data being processed therein. The HDD 10d stores other programs to be executed by the CPU 10a and data related to buying and selling orders. The I/F unit 10f performs data format conversions and protocol conversions between the transaction supporting apparatus 10 and the investor clients 13-1 through 13-4 via network 12. The I/F unit 10f also supplies the display unit 11 with an image signal. The I/F unit 10e performs data format conversions and protocol conversions between the transaction supporting apparatus 10 and the securities transaction server 15 via network 14.

The display unit 11, which may, for example, be a CRT (Cathode Ray Tube) monitor, displays images formed by the image signal received via the I/F unit 10f. The network 12, which may, for example, connect with the Internet, transfers information between the transaction supporting apparatus 10 and the investor clients 13-1 through 13-4. The investor clients 13-1 through 13-4, which may, for example, be personal computers, send buying and selling orders from investors to the transaction supporting apparatus 10, and receive information transmitted by the transaction supporting apparatus 10, the received information being displayed on the display unit 11. The network 14 may, for example, be a leased line, over which information is transferred between the transaction supporting apparatus 10 and the securities transaction server 15. This securities transaction server 15 is installed in a securities exchange, and performs an agreement process for buying and selling orders sent by the transaction supporting apparatus 10.

FIG. 2 illustrates only one transaction supporting apparatus 10. However, in practice, a plurality of transaction supporting apparatuses would be connected to the securities transaction server 15 via the network 14 or another network, and a plurality of investor clients would be connected to each transaction supporting apparatus.

Operation of the system illustrated in FIG. 2 is described immediately below.

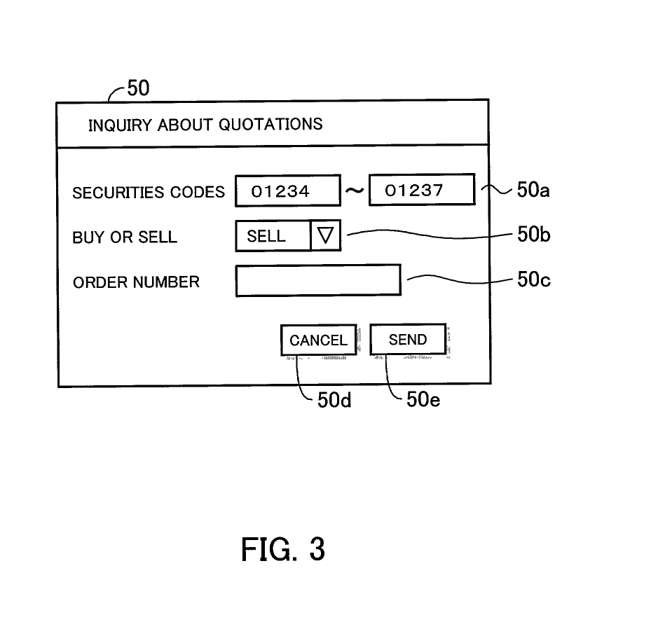

It is assumed that an input device (not shown) of the investor client 13-1 is operated to ask for quotations on stocks that are traded in the securities transaction server 15. In this case, a screen 50 shown in FIG. 3 is displayed at the investor client 13-1, on which screen text boxes 50a through 50c, a “cancel” button 50d, and a “send” button 50e appear.

A Securities code (that is a unique number that specifies a company that issues shares of securities) is input to each of the text boxes 50a. The text box 50b is used to specify either sale or purchase of the stocks. The text box 50c is used to input an order number to inquire about a previously placed order. Note that the transaction supporting apparatus 10 notifies the investor client 13-1 of the order number. The “cancel” button 50d is used to cancel the order currently being placed. The “send” button 50e is used to inquire about market quotations under the specified conditions.

In the example illustrated in FIG. 3, a sale of stocks with stock codes 01234 to 01237 is specified. No order number is input to the text box 50c.

When the “send” button 50e is clicked after the necessary items are input on the screen 50, information that has been input is sent via the network 12 to the transaction supporting apparatus 10. Then, the transaction supporting apparatus 10 sends an inquiry about the quotations on the stocks to the securities transaction server 15 through the network 14. Upon receiving information showing an answer to the inquiry, the transaction supporting apparatus 10 supplies the investor client 13-1 with the information.

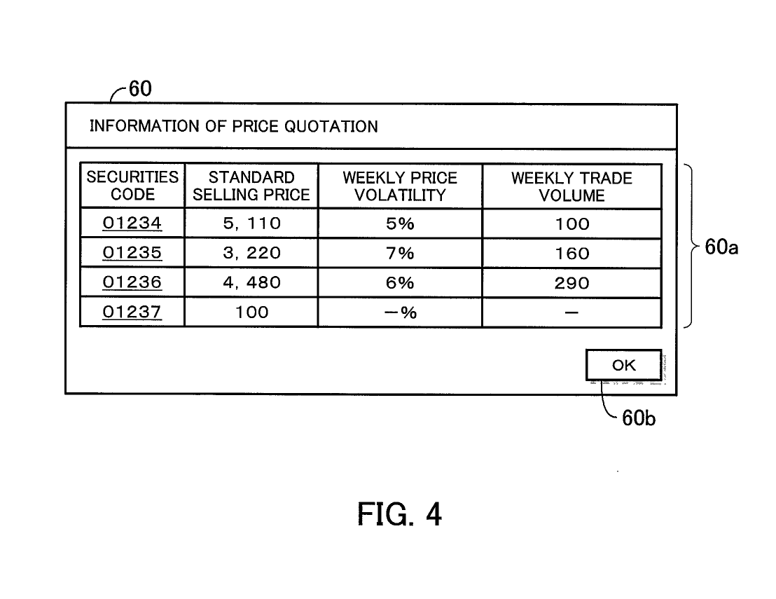

FIG. 4 illustrates a screen 60 displayed at the investor client 13-1 that has received an answer to an inquiry. In this example, the screen 60 has an area 60a in which a list of items of information concerning transactions on stocks specified by securities codes of 10234 to 01237 is displayed. An “OK” button 60b that is clicked when closing the screen is displayed on a lowermost part of the screen. Each of the securities codes is a hot text. When a desired securities code is clicked, a buying or selling order for the corresponding stock can be issued promptly (the details of this operation will be described later). The standard selling price shown on the screen 60 is the selling price at the time of click (for example, an averaged selling price). A weekly volatility indicates a ratio of price change over one week. A weekly trade volume indicates a volume of trade that has been completed during one week.

If a hot text of “01234” is specified, this creates an order screen for inputting an order for shares of the stock specified by the securities code 01234.

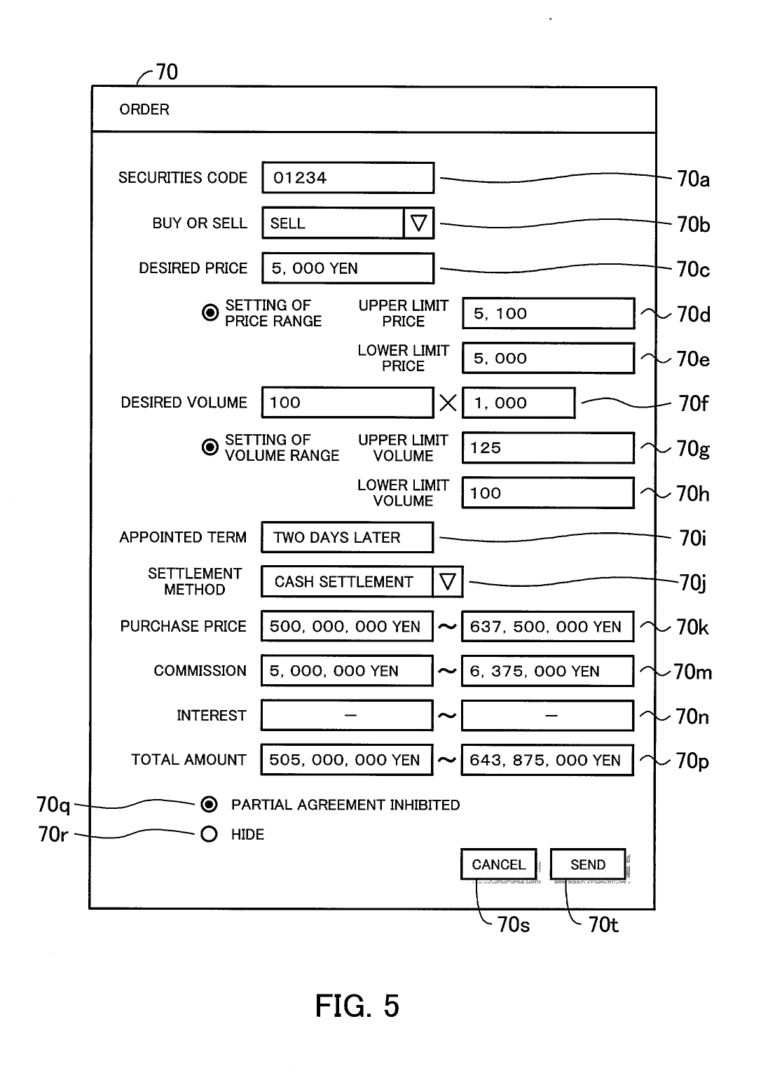

FIG. 5 illustrates an example of an order screen 70, on which text boxes 70a through 70p, check boxes 70q and 70r, a “cancel” button 70s, and a “send” button 70t appear.

A securities code of a stock to be traded is input to the text box 70a. An indication of a buying or a selling order is input to the text box 70b. A desired price of the stock to be traded is input to the text box 70c. An upper limit price of the stock to be traded is input to the text box 70d. A lower limit price of the stock to be traded is input to the text box 70e. It is to be noted that the text boxes 70d and 70e are enabled only when check boxes provided at the left-hand sides thereof are checked.

A desired volume of the stock to be traded is input to the text box 70f. An upper limit volume of the stock to be traded is input to the text box 70g. A lower limit volume of the stock to be traded is input to the text box 70h. The text boxes 70g and 70h are enabled only when check boxes provided at their left-hand sides are checked.

An appointed term of payment for the trade is input to the text box 70i. A method of settlement, that is, cash settlement or confidence settlement, is input to the text box 70j. Purchase prices calculated based in items of data input to the text boxes 70d, 70e, 70g and 70h is indicated in the text boxes 70k. In the example illustrated in FIG. 5, the text box 70k on the left-hand side indicates a price of 500,000,000 yen obtained by multiplying the lower limit price and the lower limit volume, and the other text box 70k indicates a price of 637,500,000 yen obtained by multiplying the upper limit price and the upper volume.

A buying or selling commission is indicated in the text boxes 70m. In the example illustrated in FIG. 5, two service charges respectively equal to 1% of the lowest and highest purchace prices are indicated in the text boxes 70m.

An interest that depends on the appointed term appears in the text box 70n when confidence settlement is chosen. The total of the purchace price, the commission and the interest is indicated in the text box 70p.

The check box 70q is checked when partial agreement between the buying and selling orders is inhibited. The check box 70r is checked when the buying or selling order is inhibited from being shown to other investor clients. The “cancel” button 70s is operated when the order is canceled. The “send” button 70t is operated when the buying or selling order having the items that have been input is issued.

When the “send” button 70t is operated after the all items of data for making an order are input on the order screen 70, this order is sent to the transaction supporting apparatus 10 through the network 12. The transaction supporting apparatus 10 temporarily stores information concerning the received order in the HDD 10d, and then sends it to the securities transaction server 15 via the network 14. The securities transaction server 15 displays the contents of the received order on a trading information board when the received order indicates “partial agreement inhibited” (the check box 70r is blank).

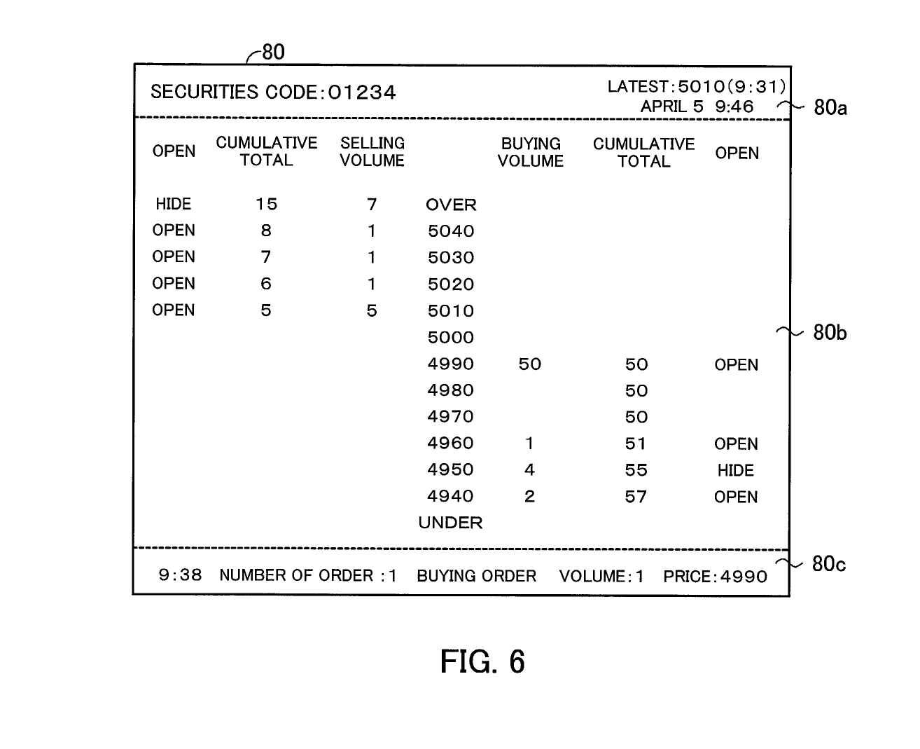

FIG. 6 illustrates a snapshot of the trading information board before the selling order from the investor client 13-1 is reflected thereon. In this example, a securities code “10234” is indicated in a display area 80a defined at the top of a window 80. The latest price “5010” of the stock assigned the securities code 01234 is indicated in an upper right portion of the display area 80a. Numerals (9:31) in a parenthesis indicate the time when the last trading of the stock was executed at the indicated price. Numerals just below the current price and the latest trading time indicate the current date and time.

Selling orders are arranged from the top in a decreasing order of selling price in a left-hand side of a trading status display area 80b. Buying orders are arranged in the decreasing order of purchase price in a right-hand side of the trading status display area 80b. A “SELLING VOLUME” indicates the volume of the stock for each selling order. A “BUYING VOLUME” indicates the volume of the stock for each buying order. The lowest digit of the volume denotes the thousand's place. For example, a figure “1” denotes one thousand. A “CUMULATIVE TOTAL” is associated with each price and indicates the number of selling orders (buying orders) having prices equal to or lower (higher) than the price. Symbols of “HIDE” and “OPEN” indicated in columns of “OPEN” denote a hidden order and an open order, respectively, and depend on the status of the check box 70r shown in FIG. 5.

A display area 80c at the bottom of the window 80 indicates a new buying or selling order together with the date and time when the new order was accepted. In the example shown in FIG. 6, the display area 80c shows that a new buying order for a volume of 1 (1000 shares) at a price of 4990 was accepted at 9:38.

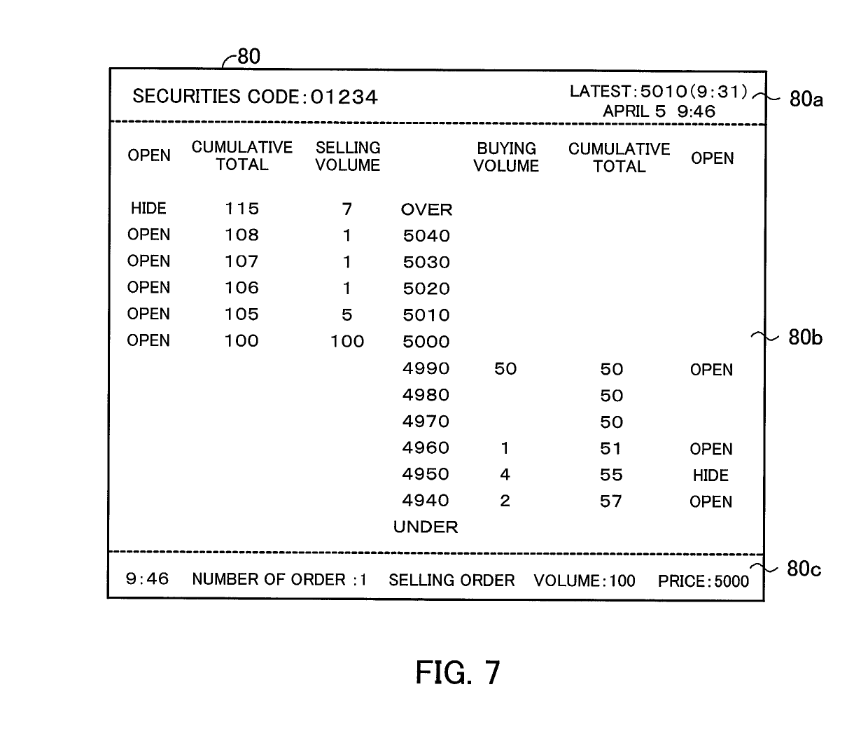

When the “send” button 70t is clicked on the screen shown in FIG. 5 in the situation shown in FIG. 6, the trading information board is updated as shown in FIG. 7. In FIG. 7, a buying order for a volume of 100 at a price of 5000 accepted at 9:46 is indicated in the display area 80c. Then, the new order is indicated in the low end of the selling orders arranged in the display area 80b. Only the desired price and volume are indicated on the trading information board shown in FIG. 7, while the upper and lower limit prices and the upper and lower limit volume are not indicated thereon.

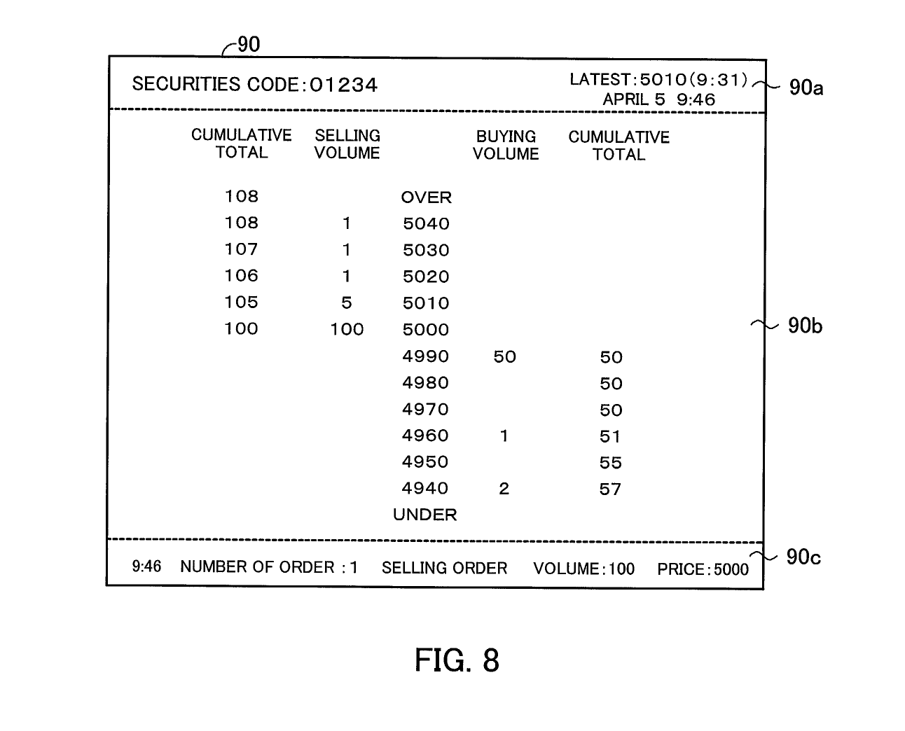

The above trading information board is displayed on the display unit 11 of the transaction supporting apparatus 10 installed in the securities company. On the other hand, a screen 90 as shown in FIG. 8 is illustrated on the display units of the investor clients 13-2 through 13-4. Symbols “HIDE” and “OPEN” indicating whether the orders should be open to other investors are not shown on the screen 90. In addition, the orders indicated together with “HIDE” on the screen 70 shown in FIG. 7 are not displayed on the screen 90 shown in FIG. 8, and are not reflected on the cumulative total.

As described before, each order can be specified as a hidden order by checking the check box 70r on the screen 70 shown in FIG. 5. In the example shown in FIG. 5, the check box 70r has not been checked, and the order issued through the screen 70 is displayed at the investor clients 13-2 through 13-4.

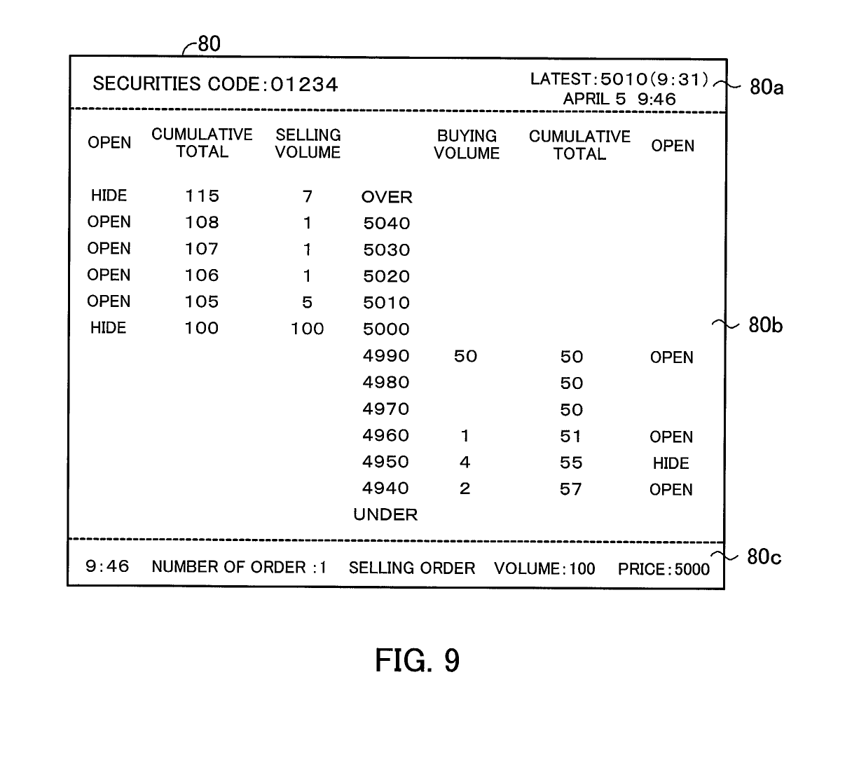

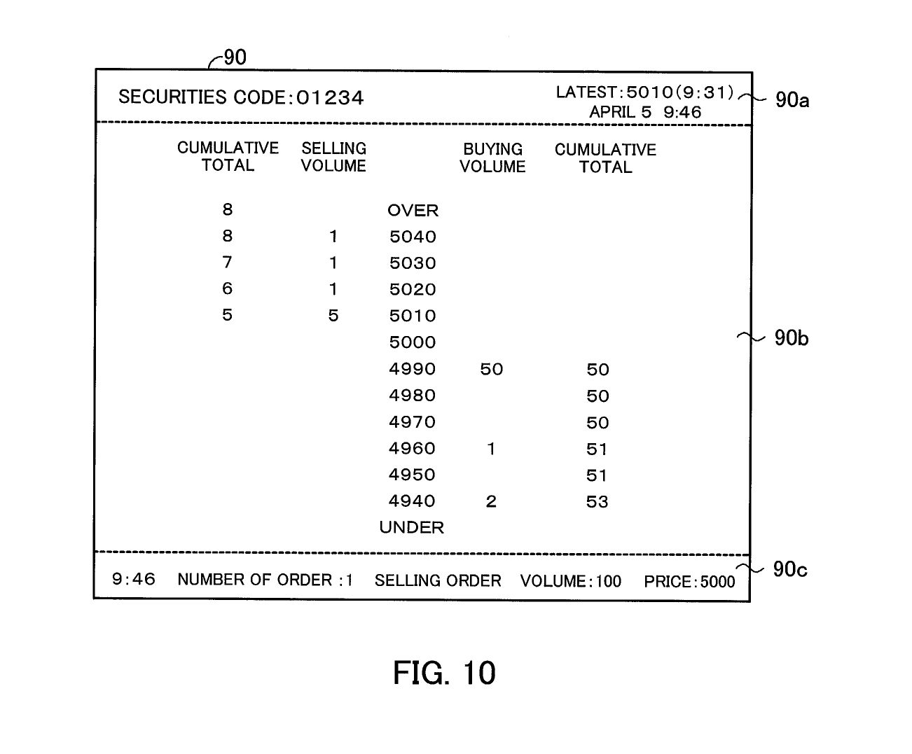

In contrast, when the check box 70r has been checked, a screen 80 shown in FIG. 9 is created on the display unit 11 of the transaction supporting apparatus 10. In this example, a mark “HIDE” is attached to an order for a volume of 100, so that this order is not open. FIG. 10 illustrates a screen 90 displayed at each of the investor clients 13-2 through 13-4. The above order for a volume of 100 is not indicated on the screen 90, and is not reflected on the cumulative total.

The hidden order results in an advantage, particularly when a big order is issued. A big order may cause considerable fluctuations in the market price. The setting of the order as a hidden order would enable trading without considerable fluctuations in the market price resulting from big orders.

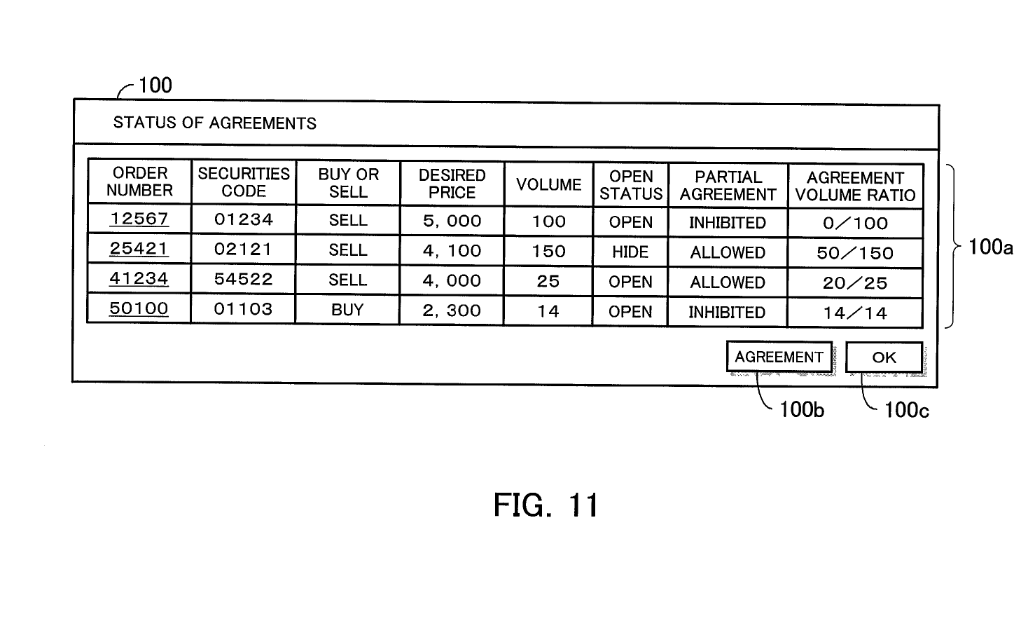

FIG. 11 illustrates an example of a screen 100, which displays the status of agreements between buying and selling orders. In this example, a display area 100a shows attribute information and the agreement volume ratio for each order. For instance, the first row of a table on the screen 100 is related to a selling order issued through the screen shown in FIG. 5, and indicates an order number of “12567”, a securities code of “01234”, a “sell” order, a desired price of “5000”, a volume of “100”, an “open” order, and inhibition of partial agreement. Further, the first row indicates an agreement volume ratio of “0/100” (a volume of 100 has not come to agreement at all).

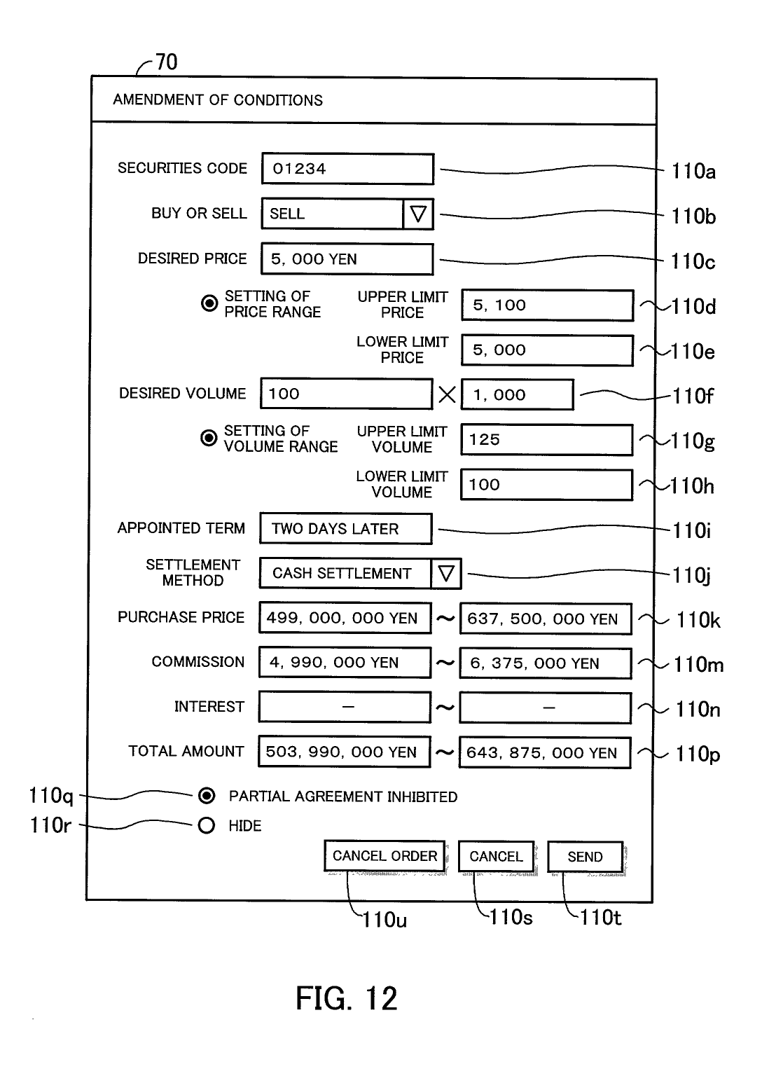

Each of the order numbers displayed on the screen 100 is a hot text. If an investor wishes to amend the conditions on the previously placed buying or selling order, he or she clicks on the related order number. This results in a screen 110 for inputting an amendment of conditions shown in FIG. 12. Thus, the investor amends the conditions on the screen 110, so that the previously placed order can be amended so as to have amended conditions.

For instance, the investor operates the text box 110e to amend the lower limit of the desired price from 5000 to 4990, and operates the text box 110q to cancel the setting of inhibition of partial agreement. Then, the investor clicks the “send” button 110t. This causes related information to be sent to the transaction supporting apparatus 10 through the network 12.

The transaction supporting apparatus 10 refers to the received information, and amends related items of the information stored in the HDD 10d. Then, the transaction supporting apparatus 10 requests the securities transaction server 15 to amend the previously placed order through the network 14. The securities transaction server 15 receives the request to amend the order, and executes a process for amending the conditions on the previously placed order. Thus, the selling order displayed on the screen 70 shown in FIG. 5 is amended in such a way that the lower limit of the desired price is amended from 5000 to 4990 and partial agreement is released from inhibited status.

The selling order thus amended matches with a buying order for a volume of “50” at a price of “4990” displayed on the screen 80 shown in FIG. 6. Thus, the securities transaction server 15 executes a process for making an agreement between the buying and selling orders. Then, the securities transaction server 15 informs the transaction supporting apparatus 10 and the transaction supporting apparatus that issued the buying order having a specified price of 4990 that the agreement has been made.

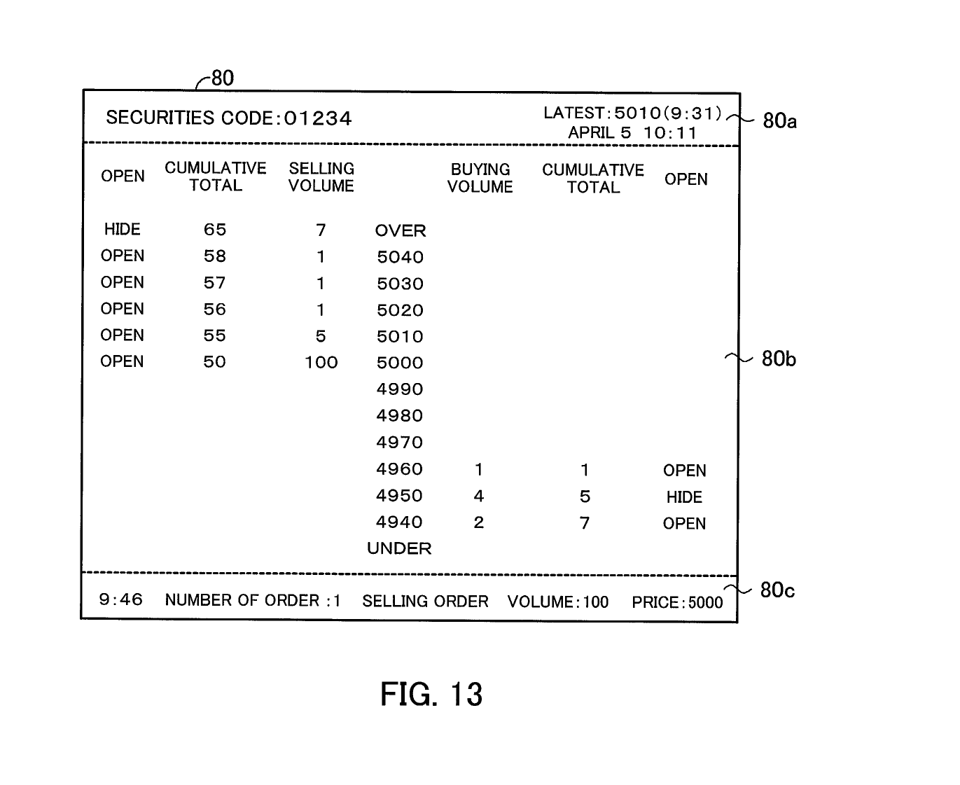

This changes the screen 80 on the display unit 11 of the transaction supporting apparatus 10, as shown in FIG. 13. In FIG. 13, the buying order that has been matched with the selling order is deleted from the screen 80, and the volume for sale is reduced from 100 to 50.

As described above, the present embodiment makes it possible to amend the conditions on the previously placed order. This allows the investors to watch the market situation and complete a transaction under the most advantageous conditions.

The example shown in FIG. 13 shows that partial agreement between the buying and selling orders has been made and the remainder of shares of stock may continuously be on sale or may be placed out of trading. The latter can be done by operating a “cancel order” button 110u on the screen 110 shown in FIG. 12. This causes the inventor client 13-1 to issue a request for cancellation of the selling order against the transaction supporting apparatus 10. Then, the transaction supporting apparatus 10 deletes the specified selling order stored in the HDD 10d, and requests the securities transaction server 15 to cancel the order.

In response to this request, the securities transaction server 15 deletes the corresponding order from the trading information board, so that the selling order requested to be canceled is no longer subject to trading.

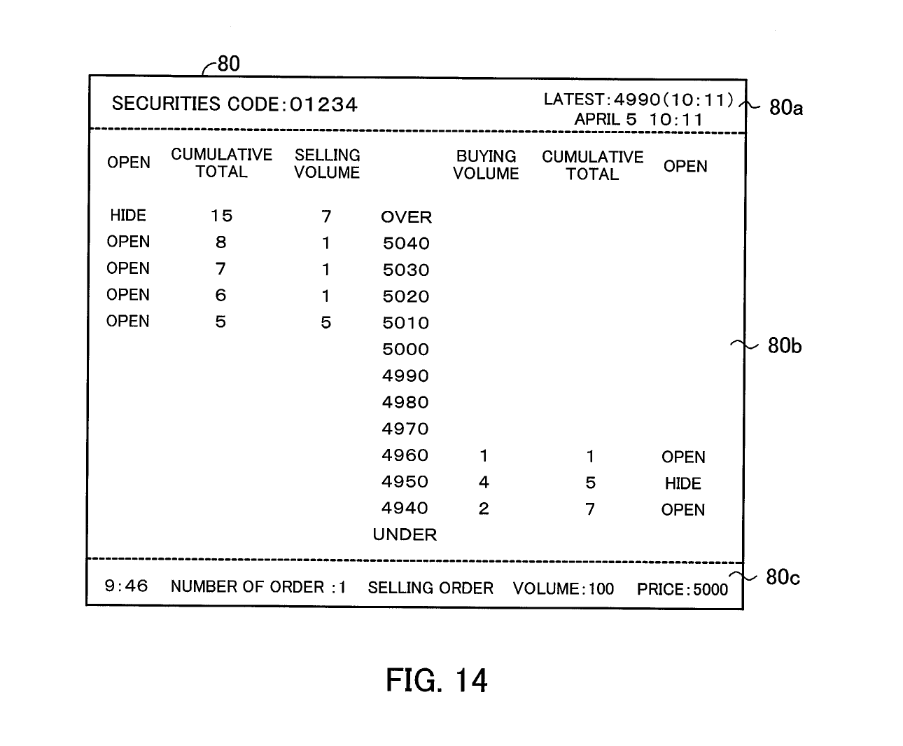

At that time, the display unit 11 of the transaction supporting apparatus 10 shows the screen 80, as shown in FIG. 14. As compared with FIG. 13, the order for a volume of 50 at a price of 5000 has been deleted from the screen 80.

Although not described in regard to the present embodiment, agreement between buying and selling orders can be made in the transaction supporting apparatus 10 without sending these orders to the securities transaction server 15 if one of the investor clients 13-2 through 13-4 has issued or newly issues a buying order while a buying order from the investor client 13-1 has been placed. Since agreement between the buying and selling orders can be made in the transaction supporting apparatus 10, the transaction can be promptly completed.

It is possible to give priority to hidden orders so that the agreement making process for the hidden orders can be performed in preference to open orders. Thus, an agreement with big orders, which may not be set open, can be made in preference to other orders.

According to the present embodiment of the invention, it is possible to specify not only the price and volume but also the upper and lower limits of the desired price and the upper and lower limits of the desired volume. This facilitates trading under the conditions desired by the investors.

According to the present embodiment, the conditions on the previously placed buying or selling order can be amended. This allows the investors to watch the market situation and complete a transaction under the most advantageous conditions.

The present embodiment is capable of canceling a previously placed order or an order that has partially agreed. This makes it possible to appropriately cancel an order on the basis of the market situation.

The present embodiment is capable of permitting and inhibiting a partial agreement, so that investors' requests can flexibly be met.

The present embodiment is capable of specifying whether an order should be open or hidden. Thus, a big order could be traded without affecting the market.

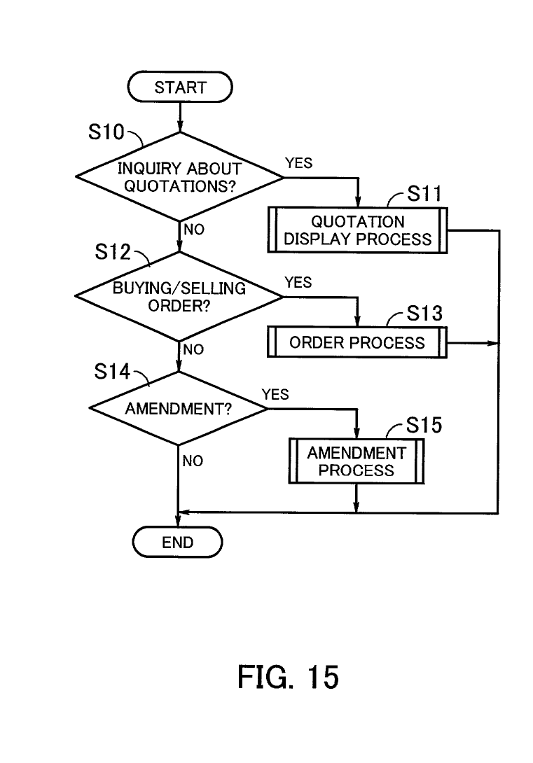

A description will be given, with reference to FIGS. 15 through 21, of flowcharts describing processes executed in the present embodiment of the invention sown in FIG. 2.

FIG. 15 is a flowchart of a main process executed by the transaction supporting apparatus 10 shown in FIG. 2. The main process starts with step S10 after initiated.

The CPU 10a determines whether an inquiry about quotations on stocks has been received from a given investor client. If the answer of step S10 is YES, the process proceeds to step S11. In contrast, if the answer is NO, the CPU 10a proceeds to step S12.

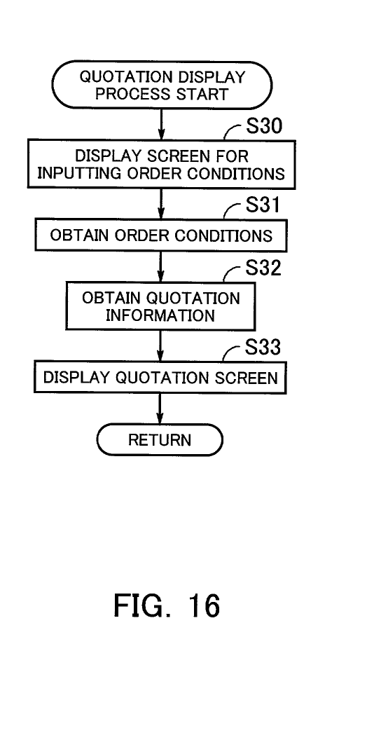

The CPU 10a executes a quotation display process for forming the screen 60 shown in FIG. 4 and causes the screen 60 to be displayed at the investor client that has asked for the quotations. The details of this process will be described later with reference to FIG. 16.

The CPU 10a determines whether a buying or selling order from an investor client has been received. If the answer of this step is YES, the CPU 10a proceeds to step S13. In contrast, if the answer is NO, the CPU 10a proceeds to step S14.

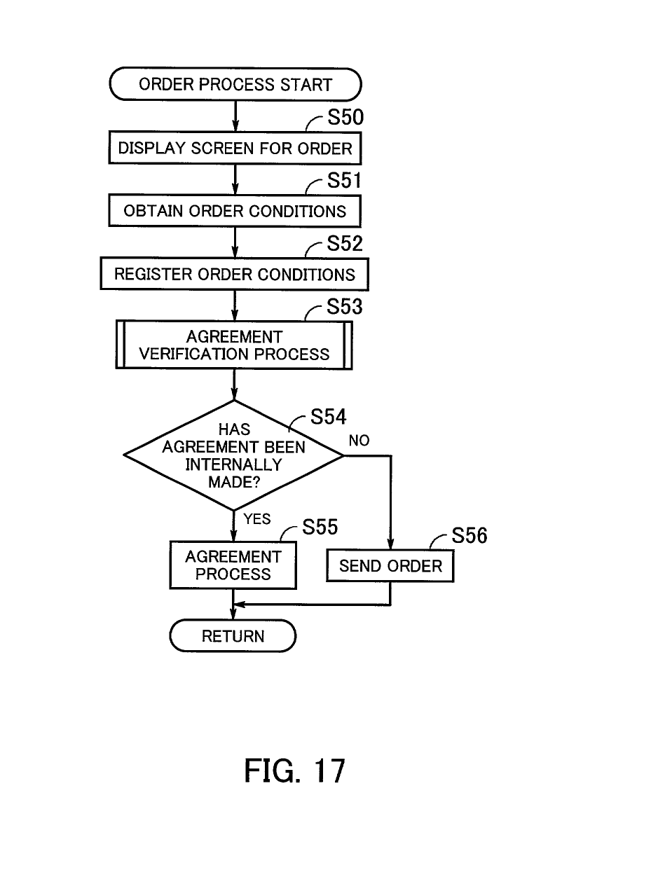

The CPU 10a executes an order process for passing the order from the investor client to the securities transaction server 15. The details of this process will be described with reference to FIG. 17.

The CPU 10a proceeds to step S15, if it receives a request to amend the conditions on a previously placed order. In contrast, if not, the CPU 10a ends the process.

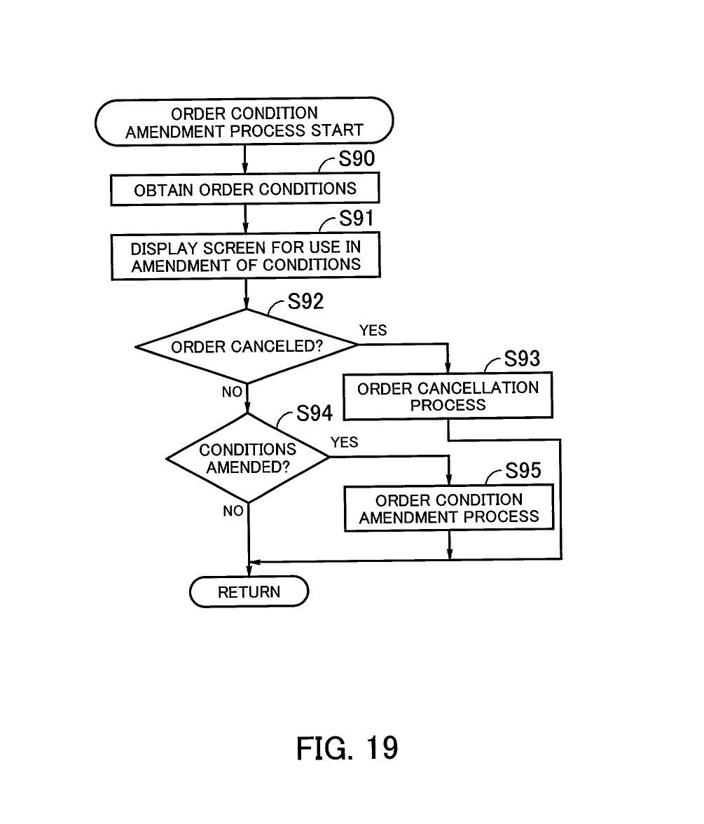

The CPU 10a executes a condition amendment process for amending the conditions placed on the buying or selling of securities. The details of this process will be described with reference to FIG. 19.

The quotation display process in step S11 shown in FIG. 15 is described immediately below with reference to FIG. 16. This process commences executing step S30.

The CPU 10a causes the screen 50 for asking for order quotations shown in FIG. 3 to be displayed on the display unit of the investor client that has inquired about the market.

The CPU 10a obtains order conditions on the inquiry that have been input on the screen 50 shown in FIG. 3.

The CPU 10a obtains information concerning the quotations on the stocks from the securities transaction server 15.

The CPU 10a causes the quotation screen 60 shown in FIG. 4 to be displayed on the display unit of the investor client that has asked for the quotations.

The order process in step S13 shown in FIG. 15 is described immediately below with reference to FIG. 17. The CPU 10a commences executing step S50.

The CPU 10a causes the order screen 70 shown in FIG. 5 to be displayed on the display unit of the investor client that has made a request.

The CPU 10a obtains the conditions for buying or selling that have been input on the order screen 70.

The CPU 10a registers the obtained conditions in the HDD 10d.

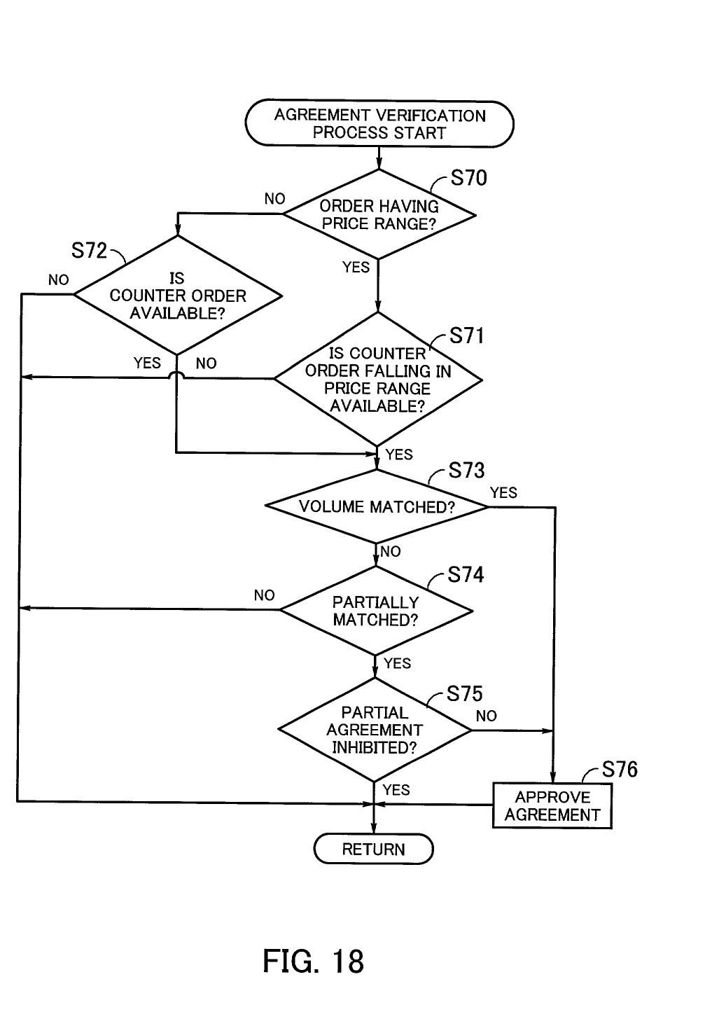

The CPU 10a executes an agreement verification process for verifying whether the orders from the investor clients 13-1 through 13-4 arrive at an agreement. The details of the agreement verification process will be described later with reference to FIG. 18.

The CPU 10a verifies whether an agreement has been made within the transaction supporting apparatus 10 (an agreement between the orders passed to the transaction supporting apparatus 10). If such an agreement is made within the transaction supporting apparatus 10, the CPU 10a proceeds to step S55. If not, the CPU 10a proceeds to step S56.

The CPU 10a executes a process for approving the agreement that has been made within the transaction supporting apparatus 10.

The CPU 10a sends the order to the securities transaction server 15.

The agreement verification process in step S53 shown in FIG. 17 is described immediately below with reference to FIG. 18.

The CPU 10a verifies whether the subject order obtained in step S51 shown in FIG. 17 has a price range.

The CPU 10a refers to the HDD 10d and determines whether a counter order that falls within the specified price range of the subject order is available. If the answer of step S71 is YES, the CPU 10a proceeds to step S73. If not, the CPU 10a ends the process. If the buying and selling orders have respective price ranges, the CPU 10a determines whether their price ranges overlap each other.

The CPU 10a determines whether a counter order that is matched with the subject order in terms of price is available. If the answer of step S72 is YES, the CPU 10a proceeds to step S73. If not, the CPU 10a ends the process. If the counter order has a price range, the CPU 10a determines whether the price range of the subject order falls within that of the counter order.

The CPU 10a determines whether the volume of the counter order matches with that of the subject order. If one or both of the orders have respective volume ranges, the CPU 10a determines if the volumes of the orders overlap. If the answer of step S72 is YES, the CPU 10a proceeds to step S76. If not, the CPU 10a proceeds to step S74.

If it is determined that the volumes of the orders are partly matched with each other, the CPU 10a proceeds to step S75. If not, the CPU 10a ends the process.

The CPU 10a ends the process if a partial agreement in terms of volume is inhibited. If not, the CPU 10a proceeds to step S76.

The CPU 10a executes a process for approving the agreement.

The order condition amendment process in step S15 shown in FIG. 15 is described immediately below with reference to FIG. 19. This process starts with step S90.

The CPU 10a asks the securities transaction server 15 to obtain the order conditions placed on the buying or selling.

The CPU 10a causes the screen 110 for use in amendment of conditions shown in FIG. 12 to be displayed on the display unit of the investor client that has asked for amendment of conditions.

The CPU 10a determines whether the “cancel order” button 110u has been operated on the screen 110. If the answer of step S92 is YES, the CPU 10a proceeds to step S93. If not, the CPU 10a proceeds to step S94.

The CPU 10a executes an order cancellation process for asking the securities transaction server 15 to cancel the corresponding order.

The CPU 10a determines whether the order conditions have been amended on the screen 110 shown in FIG. 12 and the “send” button 10t has been operated. If the answer of this step is YES, the CPU 10a proceeds to step S95. If not, the CPU 10a ends the process.

The CPU 10a executes the order condition amendment process for requesting the securities transaction server 15 to amend the order conditions.

The above-mentioned flowcharts describe the processes executed by the transaction supporting apparatus 10.

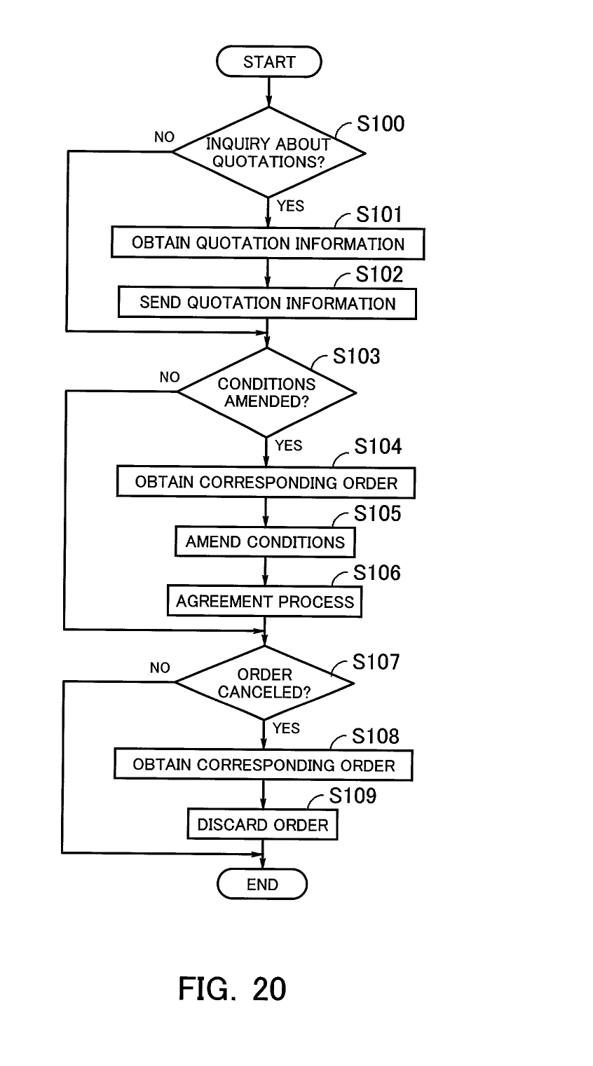

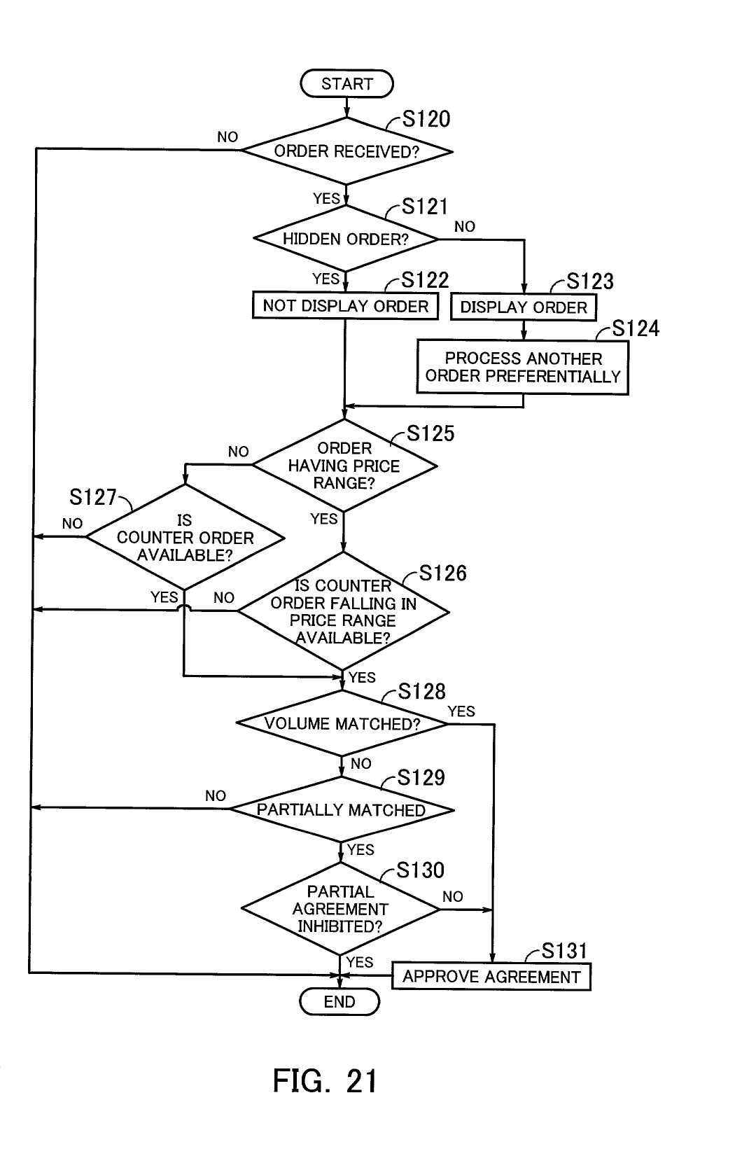

A description will be given, with reference to FIGS. 20 and 21, of flowcharts describing processes executed by the securities transaction server 15.

FIG. 20 is a flowchart of a process executed by the securities transaction server 15 when receiving an inquiry about quotations on stocks from the transaction supporting apparatus 10 and receiving a request for cancellation of order. The securities transaction server 15 commences executing step S100.

The securities transaction server 15 determines whether an inquiry about quotations on stocks has been received from the transaction supporting apparatus 10. If the answer of this step is YES, the securities transaction server 15 proceeds to step S101. In contrast, if not, the server 15 proceeds to step S103.

The securities transaction server 15 obtains information about the quotations that the transaction supporting apparatus 10 has asked for.

The securities transaction server 15 sends the obtained information concerning the quotations to the transaction supporting apparatus 10.

The securities transaction server 15 verifies whether a request for amendment of the order conditions placed on the buying or selling of securities has been issued by the transaction supporting apparatus 10. If the answer of this step is YES, the server 15 proceeds to step S104. If not, the server 15 proceeds to step S107.

The securities transaction server 15 obtains the corresponding order.

The securities transaction server 15 amends the conditions involved in the obtained order.

The securities transaction server 15 executes an agreement process under the conditions thus amended.

The securities transaction server 15 determines whether the “cancel order” button 110u has been operated on the screen 110 shown in FIG. 12 and the order has thus been canceled. If the order has been canceled, the server 15 proceeds to step S108. If not, the server 15 ends the process.

The securities transaction server 15 obtains the corresponding order.

The securities transaction server 15 performs a process for discarding the obtained order. Thus, this order is removed from the trading information board.

A description will be given, with reference to FIG. 21, of a process executed by the securities transaction server 15 when receiving a buying or selling order from the transaction supporting apparatus 10. This process starts with step S120.

The securities transaction server 15 determines whether a buying or selling order has been received. If the server 15 has received an order, the server 15 proceeds to step S121. If not, the server 15 ends the process.

The securities transaction server 15 determines whether the subject order is a hidden order. If it is determined that the subject order is a hidden order, the server 15 proceeds to step S122. If not, the server 15 proceeds to step S123.

The securities transaction server 15 does not display the subject order on the trading information board.

The securities transaction server 15 displays the subject order on the trading information board.

The securities transaction server 15 executes the agreement process for another order in preference. Thus, the agreement process for the hidden order can be preferentially executed.

The securities transaction server 15 determines whether the subject order has a price range. If the answer of this step is YES, the server 15 proceeds to step S126. If not, the server proceeds to step S127.

The securities transaction server 15 determines whether a counter order that falls in the price range of the subject order is available. If the answer of this step is YES, the server 15 proceeds to step S128. If not, the server 15 ends the process. In case where the counter order has a price range, the server 15 determines whether the price ranges of the subject and counter orders partially overlap each other.

The securities transaction server 15 determines whether a counter order that is matched with the subject order in terms of price is available. If the answer of this step is YES, the server 15 proceeds to step S128. If not, the server 15 ends the process.

The securities transaction server 15 determines whether the volume of the counter order matches with that of the subject order. If the answer of this step is YES, the server 15 proceeds to step S131. If not, the server 15 proceeds to step 129.

The securities transaction server 15 determines whether the volume of the subject order matches with that of the counter order. If the volume of the subject order partially matches with that of the counter order, the server 15 proceeds to step S130. In other cases, the server 15 ends the process.

The securities transaction server 15 determines whether one of the involved orders having the price range that matches the other is inhibited from being subject to partial agreement, the server 15 ends the process. If not, the server 15 proceeds to step S131.

The securities transaction server 15 executes a process for approving the agreement.

According to the above-described procedure, the embodiment shown in FIG. 2 can be achived.

Although the embodiment of the present invention is directed to trading stocks, the present invention is not limited thereto and may include trading of bonds.

The present invention can be implemented by computers. In this case, the processes of the transaction supporting apparatus 10 and the securities transaction server 15 are described in programs recorded on a computer-readable recording medium or media. The above-mentioned processes can be implemented when the computers execute the programs. Typical examples of a computer-readable recording medium are a magnetic recording apparatus and a semiconductor memory. The programs may be stored in a portable recording medium such as a CD-ROM (Compact Disk Read Only Memory) or a floppy disk, which is easily available in the market. It is also possible to store the program in a storage device of a computer connected to a network and to transfer it to another computer through the network. When the computer executes the program, it is read out from a hard disk drive or the like built in or externally connected to the computer and is loaded to the main memory.

In short, the present invention includes the steps of specifying a trading price of securities to be traded, specifying a volume of the securities, specifying conditions for buying or selling the securities, and issuing an order for the volume of the securities at the price under the conditions. Thus, it is possible to increase opportunity for making agreement within the ranges desired by investors.

The foregoing is considered as illustrate only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A transaction supporting method comprising the steps of:
(a) specifying a price of securities to be bought or sold;
(b) specifying a volume of the securities;
(c) specifying conditions for buying or selling the securities; and
(d) issuing an order for the volume of the securities at the price under the conditions.

2. The transaction supporting method according to claim 1, wherein said step (a) specifies the price of the securities that has a given range.

3. The transaction supporting method according to claim 1, wherein said step (b) specifies the volume of the securities that has a given range.

4. The transaction supporting method according to claim 1, wherein said step (c) specifies a condition that inhibits partial agreement between orders.

5. The transaction supporting method according to claim 1, further comprising a step of inhibiting the order issued in step (c) from being displayed at a terminal involved in a third party.

6. The transaction supporting method according to claim 5, further comprising a step of processing the order that is inhibited from being displayed in preference to another order.

7. The transaction supporting method according to claim 1, further comprising a step of changing the conditions on the order issued by said step (d).

8. The transaction supporting method according to claim 1, further comprising a step of canceling the order issued by said step (d).

9. The transaction supporting method according to claim 8, where in the step of canceling the order can cancels the order even if a partial agreement with another order is made.

10. A computer-readable recording medium storing a program causing a computer to function as:
means for specifying a price of securities to be bought or sold;
means for specifying a volume of the securities;
means for specifying conditions for buying or selling the securities; and
means for issuing an order for the volume of the securities at the price under the conditions.

11. A transaction supporting apparatus comprising:
means for specifying a price of securities to be bought or sold;
means for specifying a volume of the securities;
means for specifying conditions for buying or selling the securities; and
means for issuing an order for the volume of the securities at the price under the conditions.
